(19) United States
(12) Patent Application Publication
(10) Pub. No.: US 2012/0018267 A1
(43) Pub. Date: Jan. 26, 2012

(54) RELEASE FLOW HUB

(75) Inventor: PATRICK LINDEMANN, WOOSTER, OH (US)

(73) Assignee: SCHAEFFLER TECHNOLOGIES GMBH & CO. KG, Herzogenaurach (DE)

(21) Appl. No.: 13/187,568

(22) Filed: Jul. 21, 2011

Related U.S. Application Data
(60) Provisional application No. 61/367,172, filed on Jul. 23, 2010.
(60) Provisional application No. 61/477,852, filed on Apr. 21, 2011.

(51) Int. Cl. F16H 45/02; F16D 33/18

(52) U.S. Cl. 192/3.29; 192/113.35

(57) ABSTRACT

A hub assembly for a torque converter includes a hub with a circumferential groove and a seal arranged to contact an element of the torque converter. The seal is at least partially disposed in the groove. The groove has a first radial wall, a second radial wall axially offset with respect to the first radial wall, and at least one opening in the second radial wall. The seal is axially displaceable to seal against the first wall to block fluid flow between the hub and the element and to seal against the second radial wall and enable fluid flow through the opening.

### FIELD

The invention relates generally to a hub for a torque converter, and more specifically to a torque converter hub with release flow.

### BACKGROUND

Torque converters with lockup clutches are known. One example is shown in FIG. 2. FIG. 2 is a top-half cross section of prior art torque converter 100 with conventional hub 114. Torque converter 100 includes impeller assembly 102, turbine assembly 104 and stator assembly 106 axially disposed between bearings 108 and 110. Turbine assembly 104 is rotationally fixed to an input side of damper assembly 112, and damper hub 114 is rotationally fixed to the output side. That is, damper 112 is drivingly engaged with hub 114. Assembly 112 is selectively engaged with cover assembly 116 by lockup clutch 118.

Clutch 118 includes piston 120, sealed to hub 114 by seal 124 disposed in an annular groove of hub 114, and sealable to cover 116 by drive plate 126 with friction material rings 128 and 130. Seal 124 may be a dynamic seal formed of Teflon® or polytetrafluoroethylene (PTFE), for example. Piston 120 is drivingly engaged with cover 116 by drive plate 129, riveted to cover 116, and leaf spring 131, riveted to plate 129 and piston 120. When lockup is commanded by the transmission, pressure in chamber 132 between piston 120 and turbine 104 is increased, and pressure in chamber 134 between piston 120 and cover 116 is lowered. The pressure differential attempts to displace piston 120 towards cover 116, clamping plate 126 and transmitting torque from cover 116 to damper 112. Once displaced, plate 126 and rings 128 and 130 seal piston 120 to cover 116, allowing pressure to build in chamber 132, fully engaging clutch 118.

Gap 136 is designed to allow flow through converter 100 to cool the converter during a torque converter mode. That is, in an unlock mode, flow circulated through torque converter 100 enters the converter from a transmission input shaft (not shown) through orifices 138 to chamber 134. Flow must pass through gap 136 to chamber 132 and exit the converter between the input shaft and a stator shaft (not shown) for the transmission, for example. Pressure in chamber 134 urges piston 120 away from cover 116, increasing the size of gap 136 to allow sufficient cooling fluid through converter 100. This fluid flow removes heat generated during operation of impeller 102, turbine 104, and stator 106 in torque converter mode.

However, in some operating conditions of converter 100 (i.e., when turbine 104 is rotating faster than cover 116 and piston 120), hydrodynamic forces acting on piston 120 urge piston 120 farther away from cover 116, increasing gap 136 between piston 120 and cover 116. If gap 136 is large enough, the fluid exchange between chambers 132 and 134 may prevent pressure from increasing in chamber 132 and/or lowering in chamber 134, preventing lockup of clutch 118. That is, when pressure is increased in chamber 132, pressure in chamber 134 may also increase due to flow through gap 136, reducing a pressure differential between the chambers and preventing clutch 118 from engaging. Thus, there is a need for a clutch design that allows sufficient cooling flow in a torque converter mode but provides sufficient sealing during lockup mode so that piston 120 can overcome the hydrodynamic forces.

### BRIEF SUMMARY

Example aspects broadly comprise a hub assembly for a torque converter including a hub with a circumferential groove and a seal arranged to contact an element of the torque converter. The seal is at least partially disposed in the groove. The groove has a first radial wall, a second radial wall axially offset with respect to the first radial wall, and at least one opening in the second radial wall. The seal is axially displaceable to seal against the first wall to block fluid flow between the hub and the element and to seal against the second radial wall and enable fluid flow through the opening.

In an example embodiment, the at least one opening is in communication with an outer circumference of the hub. In an example embodiment, the at least one opening is a bore encircled by the second radial wall. In an example embodiment, the at least one opening includes a plurality of openings. In an example embodiment, for sealing engagement of the seal with the second wall, the fluid flow past the second radial wall is restricted to the at least one opening. In an example embodiment, the groove includes a circumferential surface and the seal includes an inner circumference radially outside of the circumferential surface.

Other example aspects broadly comprise a torque converter including a cover for driving connection with a prime mover, a hub including a groove, a piston plate sealingly engaged with the cover, an axially displaceable seal engaged with the piston plate and at least partially disposed in the groove, and first and second hydraulic chambers separated by the piston plate and the hub. In a first axial position for the seal, the seal and the hub prevent fluid exchange between the first and second hydraulic chambers, and, in a second axial position, axially offset from the first axial position, fluid exchange between the first and second hydraulic chambers is enabled.

In some example embodiments, the seal is axially displaceable by respective fluid pressure in the first and second hydraulic chambers. In an example embodiment, for a first differential of respective pressures in the first and second hydraulic chambers, the seal is axially displaceable to the first axial position, and, for a second differential of respective pressures in the first and second hydraulic chambers, the seal is axially displaceable to the second axial position. In an example embodiment, the hub includes a bore or a plurality of openings in communication with an outer circumference of the hub, and, when the seal is in the second axial position, fluid flows through the bore or the openings.

In an example embodiment, the hub is arranged for sealing engagement with an input shaft of a transmission. In an example embodiment, the hub is arranged for driving engagement with an input shaft of a transmission. In an example embodiment, the torque converter includes a damper drivingly engaged with the hub. In an example embodiment, the piston plate is drivingly engaged with the cover.

Other example aspects broadly comprise a torque converter including a piston for a torque converter clutch, a hub including a groove about a circumference of the hub, a seal in sealing engagement with the piston and at least partially disposed in the groove, and first and second fluid chambers separated at least in part by respective portions of the piston and the hub. The seal is displaceable such that, for fluid pressure in the first chamber greater than fluid pressure in the second chamber, the seal blocks fluid from passing between the first and second chambers through the groove, and, for fluid pressure in the first chamber less than fluid pressure in the second chamber, the seal contacts a wall of the groove to restrict fluid passing from the second chamber to the first chamber.

### BRIEF DESCRIPTION OF THE DRAWINGS

The nature and mode of operation of the present invention will now be more fully described in the following detailed description of the invention taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a top-half cross section of a prior art torque converter with a conventional hub;

FIG. 3 is a top-half cross section of an example embodiment of a torque converter with a release flow hub;

FIG. 4 is a back view of a release flow hub;

FIG. 5 is a section view of the hub of FIG. 4 taken generally along line 5-5 in FIG. 4;

FIG. 6 is a perspective section view of the portion of the hub shown in FIG. 5;

FIG. 7 is a partial back view of a hub assembly;

FIG. 8 is a partial cross section showing a piston-hub assembly;

FIG. 9 is a detail view of encircled region 9 in FIG. 8.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

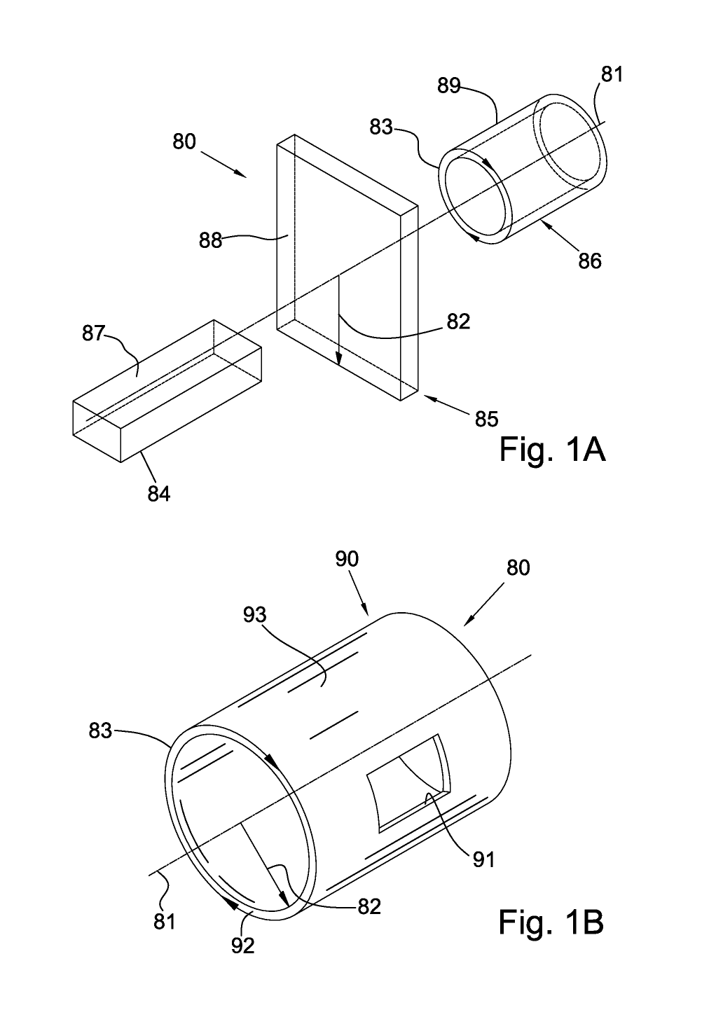

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

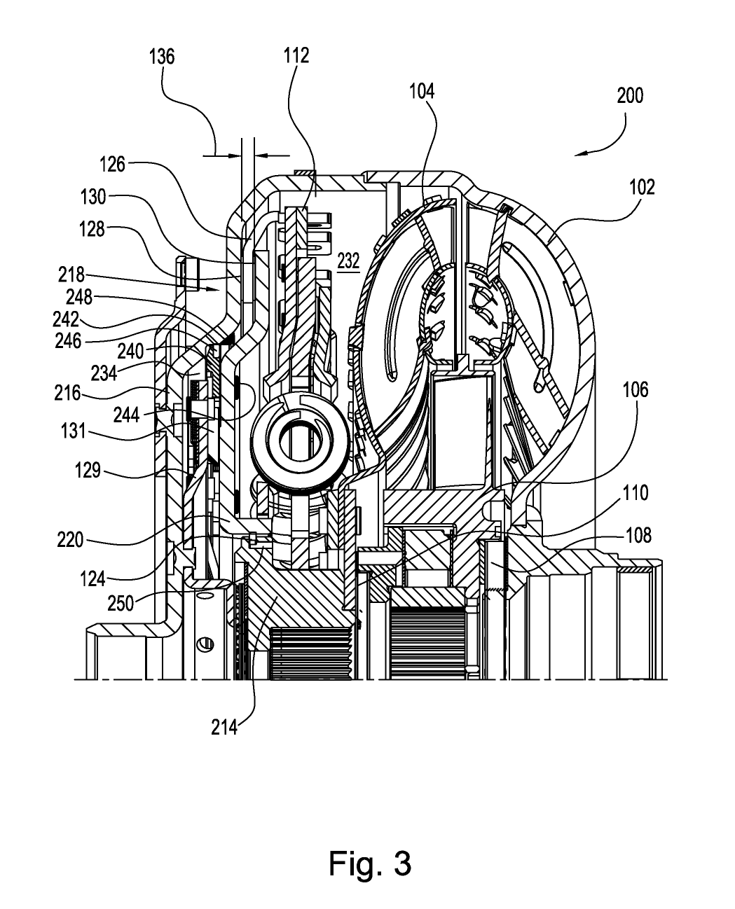

The following description is made with reference to FIG. 3. FIG. 3 is a top-half cross section of torque converter 200 with release flow hub 214. Converter 200 is similar to converter 100, except as described below. Piston 220 is drivingly engaged with cover 216 by drive plate 129, riveted to cover 216, and leaf spring 131, riveted to plate 129 and piston 220. Piston 220 includes formed sealing plate 240 and side plate 242 attached to piston 220 by rivet 244, for example, for retaining seal 246. In some embodiments, plate 240 is a flat plate, similar to plate 242, and rivet 244 includes a spacer portion separating flat plates 240 and 242. Seal 246 is arranged to seal piston 220 to cover 216. In some embodiments, cover 216 includes extended portion 248. In an example embodiment, portion 248 is a weld bead. In other embodiments, portion 248 is formed integral with cover 216.

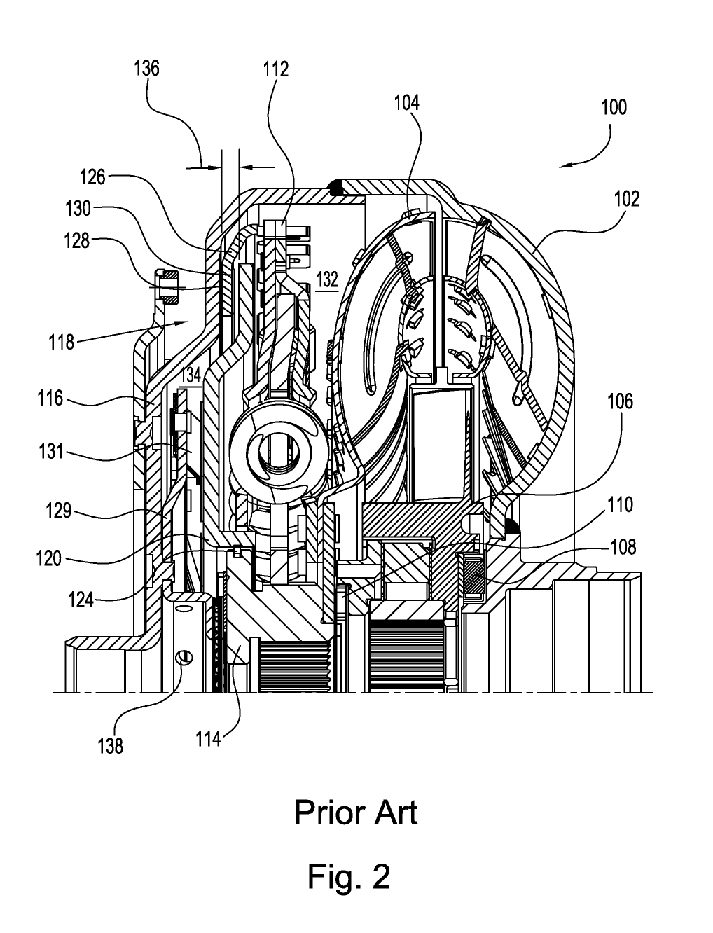

Chambers 234 and 232 of torque converter 200 are separated by piston plate 222 and hub 214. Seal 246 provides a fluid seal between the chambers so that fluid cannot leak between the chambers when there is a gap 136 between piston 220 and cover 216, similar to torque converter 100. It should be noted that gap 136 appears larger in FIG. 2 because lockup clutch 118 is shown in the open, or released condition, while lockup clutch 218 in FIG. 3 is shown in the closed, or engaged condition. When pressure is increased in chamber 232 to apply piston 220 and engage clutch 218, flow through gap 236 is restricted at seal 246, insuring a pressure differential between the two chambers and helping engagement of lockup clutch 218. As in the prior art, once piston 220 is displaced, plate 126 and rings 128 and 130 seal piston 220 to cover 216, allowing pressure to build in chamber 232, fully engaging clutch 218.

As stated above, torque converters typically require a cooling circuit to remove heat generated during torque converter mode. In torque converter 100, the cooling circuit passes through gap 136, but torque converter 200 includes additional seal 246 preventing fluid exchange and restricting cooling flow. Torque converter 200 includes hub 214 drivingly engaged with damper assembly 112 and including flow passage 250 which, in conjunction with axial displacement of seal 124, allows a sufficient of cooling flow as will be described in further detail below.

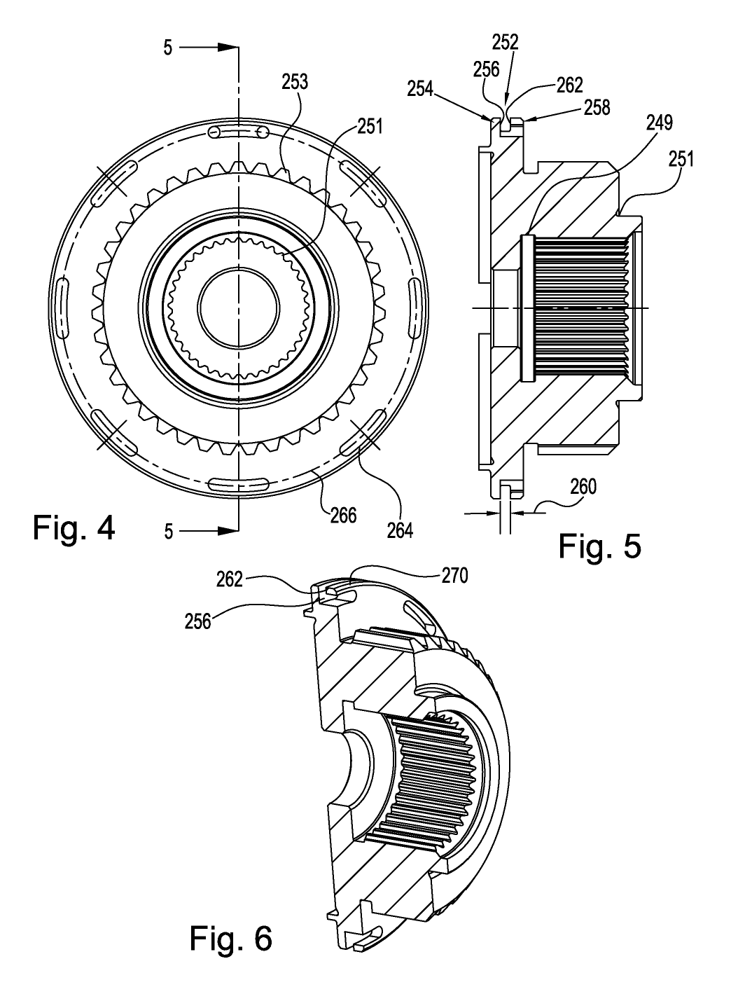

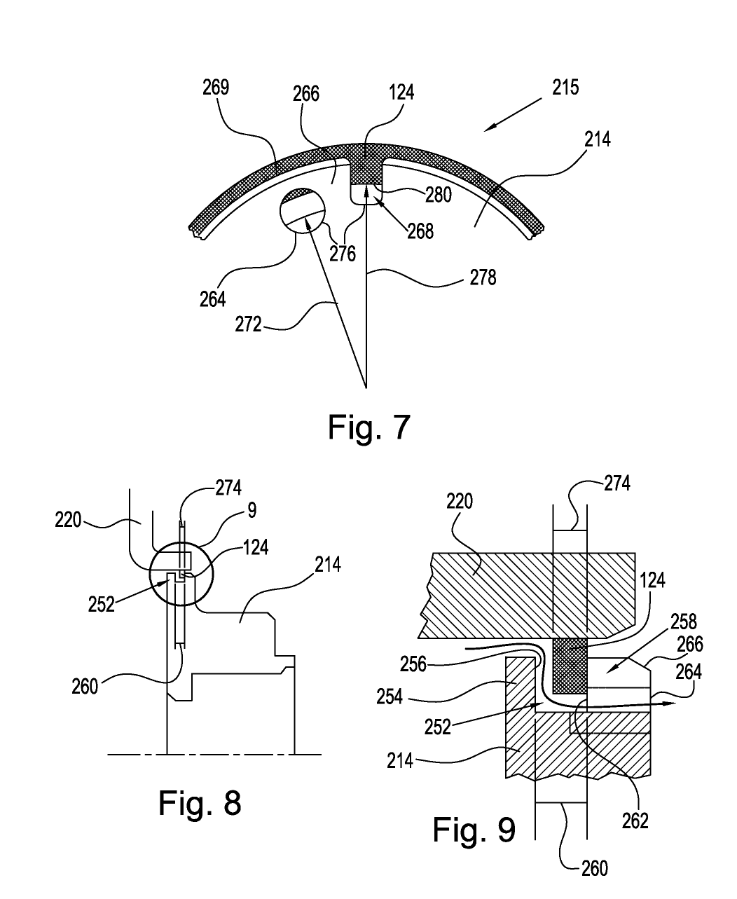

The following description is made with reference to FIGS. 4-7. FIG. 4 is a back view of turbine hub 214. FIG. 5 is a section view of hub 214 taken generally along line 5-5 in FIG. 4. FIG. 6 is a perspective section view of the portion of hub 200 shown in FIG. 5. FIG. 7 is a partial back view of hub assembly 215. Hub 214 is arranged for sealing engagement and driving engagement with the transmission input shaft, and driving engagement with damper assembly 112. Hub 214 includes inner groove 249 for receiving a seal (not shown) for sealing with the input shaft, spline portion 251 for drivingly engaging with a complementary input shaft spline (not shown), and spline portion 253 for drivingly engaging with damper assembly 112 (FIG. 3).

Hub 214 includes groove 252 for receiving seal 124 as shown in FIGS. 3 and 7. Seal 124 is at least partially disposed in groove 252 and arranged for sealing engagement with a component of torque converter 200. In an example embodiment, seal 124 is engaged with piston plate 220. Groove 252 includes radial wall 254 with continuous annular surface 256. Surface 256 is arranged for sealing engagement with seal 124. That is, seal 124 and wall 254 are sealingly engaged when seal 124 is in contact with surface 256. Otherwise stated, fluid cannot pass between seal 124 and wall 254 when seal 124 is pressed against surface 256 by pressure acting on seal 124, for example.

Hub 214 also includes radial wall 258, axially offset by distance 260 from radial wall 254. Wall 258 includes discontinuous surface 262 arranged for permitting fluid flow past seal 124. That is, fluid can pass between seal 124 and wall 258 when seal 124 is pressed against surface 262, but flow past wall 258 is restricted to openings 264 and/or 268 (ref. FIG. 7). Wall 258 includes at least one opening. In an example embodiment, wall 258 includes apertures 264 for flow passage between radial protrusions 266. Wall 258 forms a part of protrusions 266. In an example embodiment (shown in FIG. 7), apertures 264 extend to a radially outer extent of wall 258, forming radial slot 268. Otherwise stated, opening 268 is in communication with outer circumference 269 of hub 214. That is, protrusions, or castles, 266 are circumferentially offset and slot, or circumferential space, 268 between the protrusions enables fluid flow past seal 124 as described below.

As can be appreciated to one skilled in the art, the configuration of aperture 264 and/or circumferential space 268 limits the amount of fluid flow past seal 124. That is, more fluid can flow past seal 124 with a larger aperture 264 or slot 268. Aperture 264 may extend radially inside of radial wall 262. Otherwise stated, to assure sufficient flow and retain a sufficient thickness of continuous outer rim 270, diameter of aperture 264 may extend radially inward past inner radius 272 of seal groove 252. Opening 264 may be a bore encircled by radial wall 258. Aperture 264 may be extended circumferentially as shown in FIG. 4 to assure sufficient flow. A continuous rim 270 may be desirable for material handling to prevent hubs 214 from becoming interlocked in a container before assembly and/or to better retain seal 124 in groove 252.

Operation of hub 214 and seal 124 will now be described with reference to FIGS. 7-9. FIG. 8 is a partial cross section showing a piston-hub assembly. FIG. 9 is a detail view of encircled region 9 in FIG. 8. Hub 214 is assembled with piston plate 220 and seal 124. Width 260 of groove 252 is greater than width 274 of seal 124, allowing axial displacement of seal 124 in groove 252. As can be seen in FIG. 7, hub 214 includes surface 276 disposed between radial protrusions 266. In some example embodiments, surface 276 may form a portion of aperture 264 or slot 268. In an example embodiment, surface 276 may be radially aligned with inner radius 272 of seal groove 252. Seal 124 includes inside diameter 278 with circumferential surface 280 disposed radially outside of surface 276.

Because groove width 260 is larger than seal width 274, seal 124 is axially displaceable within groove 252. Seal 124 is axially displaceable by a differential pressure between chambers 232 and 234. For example, seal 124 is displaceable towards wall 254 when pressure in chamber 232 is higher than pressure in chamber 234, and displaceable towards wall 258 when pressure in chamber 234 is higher than pressure in chamber 232.

As can best be seen in FIG. 9, when seal 124 is arranged in a first axial position proximate wall 254 and surface 256, hub 214 is configured to prevent fluid exchange between hydraulic chambers 232 and 234 (FIG. 3). That is, as described above, fluid is prevented from passing by seal 124 because seal 124 and wall 254 are sealingly engaged when seal 124 is in contact with surface 256. Otherwise stated, fluid cannot pass between seal 124 and wall 254 when seal 124 is pressed against surface 256 by hydraulic pressure in chamber 232 acting on seal 124, for example.

When seal 124 is arranged in a second axial position proximate wall 258 and surface 262, axially offset from the first axial position, hub 214 is configured to permit fluid exchange between chambers 232 and 234. That is, as described above, wall 258 includes discontinuous surface 262 arranged for permitting fluid flow past seal 124. Otherwise stated, fluid can pass between seal 124 and wall 258 when seal 124 is pressed against surface 262 by hydraulic pressure in chamber 234 acting on seal 124, for example. Fluid flow (indicated by arrow 282 in FIG. 9) flows through hole 264 or between castles 266.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A hub assembly for a torque converter, comprising:
a hub including a circumferential groove, the groove including:
a first radial wall;
a second radial wall axially offset with respect to the first radial wall; and,
at least one opening in the second radial wall;
a seal arranged to contact an element of the torque converter and at least partially disposed in the groove, wherein the seal is axially displaceable:
to seal against the first wall to block fluid flow between the hub and the element; and,
to seal against the second radial wall and enable fluid flow through the opening.

2. The hub assembly of claim 1, wherein the at least one opening is in communication with an outer circumference of the hub.

3. The hub assembly of claim 1, wherein the at least one opening is a bore encircled by the second radial wall.

4. The hub assembly of claim 1, wherein the at least one opening includes a plurality of openings.

5. The hub assembly of claim 1 wherein for sealing engagement of the seal with the second wall, the fluid flow past the second radial wall is restricted to the at least one opening.

6. The hub assembly of claim 1, wherein the groove includes a circumferential surface and the seal includes an inner circumference radially outside of the circumferential surface.

7. A torque converter comprising:
a cover for driving connection with a prime mover;
a hub including a groove;
a piston plate sealingly engaged with the cover;
an axially displaceable seal engaged with the piston plate and at least partially disposed in the groove, and,
first and second hydraulic chambers separated by the piston plate and the hub; wherein:
in a first axial position for the seal, the seal and the hub prevent fluid exchange between the first and second hydraulic chambers, and,
in a second axial position, axially offset from the first axial position, fluid exchange between the first and second hydraulic chambers is enabled.

8. The torque converter of claim 7, wherein the seal is axially displacable by respective fluid pressure in the first and second hydraulic chambers.

9. The torque converter of claim 8 wherein:
for a first differential of respective pressures in the first and second hydraulic chambers, the seal is axially displaceable to the first axial position; and,
for a second differential of respective pressures in the first and second hydraulic chambers, the seal is axially displaceable to the second axial position.

10. The torque converter of claim 7, wherein:
the hub includes a bore or a plurality of openings in communication with an outer circumference of the hub; and,
when the seal is in the second axial position, fluid flows through the bore or the openings.

11. The torque converter of claim 7, wherein the hub is arranged for sealing engagement with an input shaft of a transmission.

12. The torque converter of claim 7, wherein the hub is arranged for driving engagement with an input shaft of a transmission.

13. The torque converter of claim 7, further comprising a damper drivingly engaged with the hub.

14. The torque converter of claim 7, wherein the piston plate is drivingly engaged with the cover.

15. A torque converter, comprising:
a piston for a torque converter clutch;
a hub including a groove about a circumference of the hub;
a seal in sealing engagement with the piston and at least partially disposed in the groove; and,
first and second fluid chambers separated at least in part by respective portions of the piston and the hub, wherein the seal is displaceable such that:
for fluid pressure in the first chamber greater than fluid pressure in the second chamber, the seal blocks fluid from passing between the first and second chambers through the groove; and,
for fluid pressure in the first chamber less than fluid pressure in the second chamber, the seal contacts a wall of the groove to restrict fluid passing from the second chamber to the first chamber.
